(19) United States
(12) Patent Application Publication
(10) Pub. No.: US 2012/0021176 A1
(43) Pub. Date: Jan. 26, 2012

(54) PLASTIC-WORKED LUMBER AND PROCESS FOR MANUFACTURING THE SAME

(75) Inventors: Takayuki ITO, Iwakura-shi (JP); Takashi AONO, Nagoya-shi (JP)

(73) Assignee: MYWOOD2 CORPORATION, Iwakura-shi (JP)

(21) Appl. No.: 13/232,441

(22) Filed: Sep. 14, 2011

(30) Foreign Application Priority Data
Jun. 3, 2010 (JP) 2010-127593

(51) Int. Cl. B32B 5/02; B29C 55/18

(52) U.S. Cl. 428/141; 264/280

(57) ABSTRACT

Plastic-worked lumber. PW1 and PW2 has air-dried specific gravity twice or more than those of lumber before processing NW1 and NW2 and acute crossing angles within a range of 45 degrees or less. The acute crossing angles are formed by all of annual ring lines RL on a butt end surface of the plastic-worked lumber PW1 or PW2 and a heart-side cross grain surface or a pith-side straight grain surface of the plastic-worked lumber PW1 or PW2. The plastic-worked lumber PW1 and PW2 is prepared by heating and compression to lumber NW1 or NW2 so that the lumber NW1 or NW2 is heated and compressed in a thickness direction thereof and plastically worked.

### BACKGROUND OF THE INVENTION

1. Field of the Invention

This invention relates to plastic-worked lumber that is compressed at least in a thickness direction thereof and a process for manufacturing the same, and in particular, relates to plastic-worked lumber that is manufacturable with a reduced variation in quality among products and a process for manufacturing the same.

2. Description of the Related Art

As a species of wood or lumber, cedar wood or the like having a low density and lacking in hardness is heretofore known to have hardness to withstand a practical use if it is compressed to have a high density.

In regard to this fact, a laminated plastic-worked lumber described in Japanese Patent Laid-Open Publication No. 2007-301885 is previously filed by the present applicant. The laminated plastic-worked lumber can be used for a floor, a wainscot, a table, and the like by joining a surface layer material to an inner layer material. The surface layer material is formed by compressing and compacting lumber entirely in a thickness direction thereof and the inner layer material has a prescribed groove-like cross section formed therein. In addition, the present applicant has established a technique for compacting lumber entirely in a thickness direction thereof while adjusting water content of the lumber by using a press machine or the like. (e.g. refer to Japanese Laid-Open Publication No. 2003-53705)

However, in such compressed lumber that is compacted entirely in a thickness direction thereof, all compressed lumber that is compacted at the same compression rate does not have a desired hardness unambiguously. That is, lumber that is compressed in a similar manner may be unstable in physical properties and have variation in quality among products.

Generally, wood or lumber comprises an early wood portion that forms a portion between adjacent annual ring lines and a late wood portion that forms an annual ring line. The early wood portion has a thin cell wall and a high porosity (in a cell cavity). An arrangement of annual ring lines (early wood portion, late wood portion) varies depending on lumber. Thereby, a deformation may be locally concentrated in a limited part of the lumber. The lumber may not be compressed uniformly in overall thickness, thereby having such unstable physical property and variation in quality among products as mentioned above.

Particularly, when lumber is compressed by using a press machine divided into plural parts or the like so that surfaces of the lumber and the press machine contact each other, a desired surface hardness may be often unavailable even if a degree of compression is increased, which may be due to the fact that such localized deformation by compression is often generated in an inner layer portion that is subject to a load. Moreover, a surface layer portion is hard to have a localized deformation due to compression. Thereby, it is difficult to provide lumber that tends not to have a flaw or a dent corresponding to a degree of compression.

Moreover, when lumber is not compressed uniformly in overall thickness, a dimensional change rate inside products varies depending on a change in ambient conditions. Thereby, a deformation may be generated depending on a change in ambient conditions after production.

The present invention attempts to solve such problems. It is an object of the present invention is to provide plastic-worked lumber that is physically stable with a reduced variation in quality among products and has no deformation due to a change in ambient conditions after production and still has a high hardness that allows the lumber to tend not to have a flaw or a dent. It is another object of the present invention to provide a process for manufacturing the same.

### BRIEF SUMMARY OF THE INVENTION

According to a first aspect of the invention, there is provided plastic-worked lumber having air-dried specific gravity of 0.85 or more with water content of 15% and acute crossing angles within a range of 45 degrees or less. The plastic-worked lumber is formed by applying heating and compression to lumber in a thickness direction thereof so that the lumber is heated and compressed and plastically worked, wherein a resultant plastic-worked lumber after the heating and compression is dried in the air so as to have air-dried specific gravity of 0.85 or more with water content of 15% and acute crossing angles within a range of 45 degrees or less. The acute crossing angles are formed by all of annual ring lines on a butt end surface of the plastic-worked lumber after the heating and compression and a heart-side cross grain surface or a pith-side straight grain surface of the plastic-worked lumber.

According to a second aspect of the invention, there is provided a process for manufacturing plastic-worked lumber comprising the steps of: applying heating and compression to lumber in a thickness direction thereof so that the lumber is heated and compressed and plastically worked; and drying a resultant plastic-worked lumber after the heating and compression in the air so as to have air-specific gravity of 0.85 or more with water content of 15% and acute crossing angles within a range of 45 degrees or less. The acute crossing angles are formed by all of annual ring lines on a butt end surface of the resultant plastic-worked lumber and a heart-side cross grain surface or a pith-side straight grain surface of the plastic-worked lumber.

And now heating and compressing the lumber means that external force is applied to a cross grain surface or a straight grain surface of lumber so that the lumber is heated and compressed in a direction parallel to a butt end surface of the lumber and an area of the butt end surface decreases. The cross grain surface means a surface that is in parallel with a fiber direction of lumber (in a longitudinal direction along the grain) and cut in a direction tangential to annual ring lines. The butt and surface means a surface that is cut in a direction crossing a fiber direction of lumber, namely a surface that is cut in a vertical or oblique direction of a fiber direction of lumber. In addition, the straight grain surface means a surface that is in parallel with a fiber direction of lumber and cut in a radial direction of annual ring lines of the lumber. Here, the straight grain includes a comb grain like a grain between a straight grain and a cross grain.

In addition, a plastic working that allows the lumber to be compressed entirely in a thickness direction thereof, for instance, is set so that a resultant plastic-worked lumber has approximately uniform water content entirely in a thickness direction. Such lumber that is heated and compressed entirely in a thickness direction thereof is formed by using a press machine under prescribed conditions. The press machine is divided into plural parts and the like. In addition, temperature, pressure, time, compression speed, and the like to be the prescribed conditions are determined in advance by experiment and the like with parameters such as a species of trees and water content.

Here, the lumber is heated and compressed and plastically worked so that it has air-dried specific gravity twice or more than that of the lumber before heating and compression. That is, the lumber is compressed so as to decrease a thickness by ½ or more. This allows the lumber to have a characteristic area that mechanical strength such as hardness and abrasion resistance is improved. The resultant characteristic area denotes a property of plastic-worked lumber. The lumber to be heated and compressed is led by the following points: lumber after compression decreases in angle of annual ring lines by ½ or more compared to before compression; and compression ratio (to be exact, which is represented by a difference of Tan⁻¹ between before and after compression).

In addition, acute crossing angles formed by all of annual ring lines on a butt end surface of the plastic-worked lumber and imaginary borderlines drawn in a range of 2 mm or less of a pith-side cross grain surface or a pith-side straight grain surface as viewed from the butt end surface of the plastic-worked lumber along the pith-side cross grain surface or the pith-side straight grain surface of the plastic-worked lumber are within a range of 45 degrees or less. That is, acute crossing angles formed by all of annual ring lines on a butt end surface of the lumber after heating and compression and a heart-side cross grain surface or a pith-side straight grain surface of the lumber are within a range of 45 degrees or less. The present inventors pay attention to a gradual decrease in said crossing angles when lumber before compression made of cross-grained lumber or straight-grained lumber is compressed. As a result of continuous experiment and studies by the present inventors, it is found that when acute crossing angles formed by annual ring lines on a butt end surface of lumber before heating and compression and imaginary borderlines drawn in a range of 2 mm or less of a pith-side cross grain surface or a pith-side straight grain surface as viewed from the butt end surface along the pith-side cross grain surface or the pith-side straight grain surface are 85 degrees or less or especially when acute crossing angles formed by annual ring lines of plastic-worked lumber after heating and compression and a heart-side cross grain surface or a pith-side straight grain surface of the plastic-worked lumber are within a range of 45 degrees or less, the following advantages are obtained. A resultant plastic-worked lumber is physically stable with a reduced variation in characteristic values such as hardness and abrasion resistance and has no deformation due to a change in ambient conditions after production. Moreover, the plastic-worked lumber has a significant increase in hardness and tends not to have a flaw or a dent. The said acute crossing angles are set based on this knowledge.

In addition, the annual ring lines on the butt end surface mean linear portions that have a dense layer as viewed from the butt end surface, which is a grain that shows up on the butt end surface. Moreover, the values of 85 degrees and 45 degrees shall not require exact values of 85 degrees and 45 degrees and may be approximately 85 degrees and 45 degrees, respectively. These values are appropriate values including an error depending on a species of lumber and ligneous and a small percentage of errors are embraced therein.

Especially, acute crossing angles formed by all of annual ring lines on a butt end surface of the lumber and imaginary borderlines drawn in a range of 2 mm or less of a pith-side cross grain surface or a pith-side straight grain surface as viewed from the butt end surface of the lumber along the pith-side cross grain surface or the pith-side straight grain surface are within a range of 85 degrees or less or 45 degrees or less. These values are obtained by the present inventors as follows. As a result of continuous experiment and studies by the present inventors, it is found that when straight-grained lumber before compression that is cut in a radial direction of annual ring lines and normally has acute crossing angles of 45 to 90 degrees is heated and compressed so as to have air-dried specific gravity twice or more than that of the lumber before heating and compression, lumber having crossing angles before compression within a range of 45 to 85 degrees tends not to have a crack and lumber having crossing angles before compression of more than 85 degrees has a large bending deformation of annual ring lines and may have a crack and lose commodity value in some cases. In addition, the crossing angles before compression are preferably within a range of 60 degrees or less in that it has only few cracks.

Furthermore, straight-grained lumber that is cut in a radial direction of annual ring lines and comes on the market generally has every acute crossing angle within a range of 45 to 90 degrees before compression. The acute angles are formed by all of annual ring lines on a butt end surface of the straight-grained lumber and imaginary borderlines drawn in a range of 2 mm or less of a pith-side straight grain surface as viewed from the butt end surface of the straight-grained lumber along the pith-side straight grain surface of the straight-grained lumber. Thereby, a maximum value of crossing angles of the straight-grained lumber after compression is normally 15 to 45 degrees. In addition, lumber having every acute crossing angle within a range of 0 to 45 degrees is preferably used as lumber before processing made of cross-grained lumber and to be a material of plastic-worked lumber. The acute crossing angles are formed by imaginary borderlines drawn in a range of 2 mm or less of a pith-side cross grain surface as viewed from a butt end surface of the cross-grained lumber along the pith-side cross grain surface of the cross-grained lumber and annual ring lines of the cross-grained lumber. Thereby, unless lumber is classified as cross-grained lumber or straight-grained lumber, lumber before processing that has every acute crossing angle within a range of 85 degrees or less formed by imaginary borderlines of lumber before processing and annual ring lines on a butt end surface of the lumber is preferably used as lumber before processing to be a material of plastic-worked lumber, more preferably within a range of 60 degrees or less. Consequently, every acute crossing angle formed by imaginary borderlines on a butt end surface and annual ring lines is preferably within a range of 45 degrees or less.

The air-dried specific gravity means a specific gravity when lumber is dried in the air and is normally represented by a specific gravity with water content of 15%, which is obtained by comparison with a weight of water having the same volume as a weight of dry lumber.

### EFFECTS OF THE INVENTION

According to the first aspect of the invention, the plastic-worked lumber is formed by applying external force to lumber so as to make a thickness thereof heated and compressed and make the lumber plastically worked. The lumber after heating and compression is arranged so as to have air-dried specific gravity twice or more than that of the lumber before heating and compression and acute crossing angles within a range of 45 degrees or less. The acute crossing angles are formed by all of annual ring lines on a butt end surface of plastic-worked lumber and imaginary borderlines drawn in a range of 2 mm or less of a pith-side cross grain surface or a pith-side straight grain surface as viewed from the butt end surface of the plastic-worked lumber, namely all of annual ring lines on a butt end surface of the lumber after heating and compression and a heart-side cross grain surface or a pith-side straight grain surface of the lumber after heating and compression.

Therefore, lumber is compressed entirely in a thickness direction thereof and plastically worked so that the lumber has acute crossing angles within a range of 45 degrees or less. The acute crossing angles are formed by all of annual ring lines on a butt end surface of the plastic-worked lumber and imaginary borderlines drawn along a pith-side cross grain surface or a pith-side straight grain surface as viewed from the butt end surface of the plastic-worked lumber, namely all of annual ring lines pm a butt end surface of the lumber after heating and compression and a heart-side cross grain surface or a pith-side straight grain surface of the lumber after heating and compression. Therefore, the lumber is compressed entirely in a thickness direction thereof and plastically worked and has acute crossing angles of 45 degrees or less formed by all of annual ring lines on a butt end surface of the lumber and imaginary borderlines between a pith-side cross grain surface or a pith-side straight grain surface as viewed from the butt end surface of the lumber. That is, acute crossing angles formed by all of annual ring lines on a butt end surface of the lumber after heating and compression and s heart-side cross grain surface or a pith-side straight grain surface of the lumber after heating and compression are within a range of 45 degrees or less. Therefore, almost all cells of an early wood portion are deformed due to compression and porosity (in cell cavities) is significantly lowered. The lumber is compressed almost uniformly in overall thickness and physically stable. Thereby, the lumber has reduced variation in quality among products. Moreover, as described above, the lumber is compressed almost uniformly in overall thickness and variation in dimensional change rate inside the product due to a change in ambient conditions after production. Thereby, the lumber has no deformation due to a change in ambient conditions after production. In addition, almost all cells in the early wood portion are deformed due to compression and cell walls overlap one another. Moreover, the early wood portion has a significantly lowered porosity in a cell cavity, thereby increasing a proportion of a late wood portion. Therefore, the plastic-worked lumber after heating and compression tends not to have a flaw or a dent.

Especially, the plastic-worked lumber is formed so as to have acute crossing angles within a range of 45 degrees or less. The acute crossing angles are formed by all of annual ring lines on a butt end surface of the plastic-worked lumber and imaginary borderlines drawn along a pith-side cross grain surface or a pith-side straight grain surface as viewed from the butt end surface of the lumber. Moreover, the plastic-worked lumber is prevented from having a bending deformation of annual ring lines due to heating and compression, thereby having no crack and the like. Therefore, a high quality of products may be ensured.

In addition, when a material for the plastic-worked lumber is compressed so as to have a specific gravity of 0.85 or more, the plastic-worked lumber becomes physically stable and has a reduced variation in quality among products. Moreover, when the specific gravity of the material for the plastic-worked lumber is raised to 1.05, the plastic-worked lumber has a significant increase in surface strength and stiffness such that it is hardly damaged by a stiletto heel and may have a higher dimensional stability.

According to the second aspect of the invention, a process for manufacturing the plastic-worked lumber comprises the step of applying heating and compression to lumber in a thickness direction thereof so that the lumber is heated and compressed and plastically worked. A resultant plastic-worked lumber is formed so as to have air-dried specific gravity twice or more than that of the lumber before heating and compression and acute crossing angles within a range of 45 degrees or less. The acute crossing angles are formed by all of annual ring lines on a butt end surface of the plastic-worked lumber and a heart-side cross grain surface or a pith-side straight grain surface of the plastic-worked lumber.

Therefore, lumber is compressed entirely in a thickness direction thereof and plastically worked so that the lumber has acute crossing angles within a range of 45 degrees or less. The acute crossing angles are formed by all of annual ring lines on a butt end surface of the plastic-worked lumber and imaginary borderlines drawn along the pith-side cross grain surface or the pith-side straight grain surface as viewed from the butt end surface of the plastic-worked lumber. Therefore, almost all cells in an early wood portion of the lumber are heated and compressed and porosity (in cell cavities) is significantly lowered. Thereby, the lumber is compressed almost uniformly in overall thickness and is physically stable, thereby having a reduced variation in quality among products. In addition, as described above, the lumber is compressed almost uniformly in overall thickness and has a reduced variation in dimensional change rate in products due to a change in ambient conditions after production. Therefore, the plastic-worked lumber has no deformation due to the change in ambient conditions after production. In addition, in the plastic-worked lumber, almost all cells of the early wood portion are deformed due to compression and cell walls overlap one another with a significant low porosity in the cell cavities. Then, a proportion of a late wood portion increases. Therefore, the plastic-worked lumber tends not to have a flaw or a dent.

When the plastic-worked lumber has air-dried specific gravity of 0.85 or more, the plastic-worked lumber may have properties such as hardness and abrasion resistance equal to or greater than those of ebony.

Especially, the plastic-worked lumber after compression is formed so that it has every acute crossing angle within a range of 45 degrees or less. The acute crossing angles are formed by all of annual ring lines on a butt end surface of the plastic-worked lumber and imaginary borderlines drawn along a pith-side cross grain surface or a pith-side straight grain surface as viewed from the butt end surface of the plastic-worked lumber. Moreover, the plastic-worked lumber is prevented from having a bending deformation of annual ring lines due to heating and compression, thereby having no crack and the like. Therefore, a high quality of products may be ensured.

In addition, when a material for the plastic-worked lumber is compressed so as to have a specific gravity of 0.85 or more, the plastic-worked lumber becomes physically stable and has a reduced variation in quality among products. Moreover, when the specific gravity of the material for the plastic-worked lumber is raised to 1.05, the plastic-worked lumber has a significant increase in surface strength and stiffness such that it is hardly damaged by a stiletto heel and may have a higher dimensional stability.

### BRIEF DESCRIPTION OF THE SEVERAL VIEWS OF THE DRAWINGS

FIG. 1 is a cross section of a schematic structure of a plastic-worked lumber manufacturing apparatus to manufacture plastic-worked lumber according to an embodiment of the present invention.

FIG. 2 is an explanatory drawing showing a process for manufacturing plastic-worked lumber according to the embodiment of the present invention, FIG. 2A is an explanatory drawing showing a step for supplying lumber before processing to be a material used to form the plastic-worked lumber, FIG. 2B is an explanatory drawing showing a condition in which heating and compression are started, FIG. 2C is an explanatory drawing showing a condition in which heating and compression are started in a sealed state, FIG. 2D is an explanatory drawing showing a step for controlling a steam pressure when heating and compression are performed in a sealed state, FIG. 2E is an explanatory drawing showing a condition in which cooling is performed in a sealed state, and FIG. 2F is an explanatory drawing showing a step for taking out of the plastic-worked lumber.

FIG. 3 is an explanatory drawing showing a butt end surface, a cross grain surface and a straight grain surface of lumber in case cross-grained lumber is used as plastic-worked lumber according to the embodiment of the present invention, FIG. 3A is a perspective view of lumber before processing to be a material used to form plastic-worked lumber according to the embodiment of the present invention, FIG. 3B is an elevation view of a butt end surface of the lumber before processing to be a material used to form plastic-worked lumber according to the embodiment of the present invention, FIG. 3C is a perspective view of the plastic-worked lumber according to the embodiment of the present invention, and FIG. 3D is an elevation view of a butt end surface of the plastic-worked lumber according to the embodiment of the present invention.

FIG. 4 is an explanatory drawing showing an example of plastic-worked lumber according to the embodiment of the present invention in case cross-grained lumber is used as the plastic-worked lumber according to the embodiment of the present invention, FIG. 4A is an explanatory drawing showing a case 1 before and after compression, and FIG. 4B is an explanatory drawing showing a case 2 before and after compression.

FIG. 5 is an explanatory drawing showing another example of plastic-worked lumber according to the embodiment of the present invention in case cross-grained lumber is used as the plastic-worked lumber according to the embodiment of the present invention, FIG. 5C is an explanatory drawing showing a case 3 before and after compression, and FIG. 5D is an explanatory drawing showing a case 4 before and after compression.

FIG. 6 is an explanatory drawing showing an example of plastic-worked lumber according to the embodiment of the present invention in case cross-grained lumber or straight-grained lumber is used as the plastic-worked lumber according to the embodiment of the present invention, FIG. 6E is an explanatory drawing showing a case 5 before and after compression in case cross-grained lumber is used as the plastic-worked lumber according to the embodiment of the present invention, and FIG. 6F is an explanatory drawing showing a case 6 before and after compression in case straight-grained lumber is used as the plastic-worked lumber according to the embodiment of the present invention.

FIG. 7 is an explanatory drawing showing an example of plastic-worked lumber according to the embodiment of the present invention in case straight-grained lumber is used as the plastic-worked lumber according to the embodiment of the present invention, and FIG. 7G is an explanatory drawing showing a case 7 before and after compression

FIG. 8 is Table showing values of acute crossing angles that correspond to the cases 1 to 6 according to the embodiments shown in FIGS. 4 to 6.

FIG. 9 is Table showing values of acute crossing angles that correspond to the cases 6 and 7 according to the embodiments shown in FIGS. 6 and 7.

FIG. 10 is an explanatory drawing showing a butt end surface, a cross grain surface and a straight grain surface of lumber in case straight-grained lumber is used as plastic-worked lumber according to the embodiment of the present invention, FIG. 10A is a perspective view of lumber before processing to be a material used to form plastic-worked lumber according to the embodiment of the present invention, FIG. 10B is an elevation view of a butt end surface of the lumber before processing to be a material used to form the plastic-worked lumber according to the embodiment of the present invention, FIG. 10C is a perspective view of the plastic-worked lumber according to the embodiment of the present invention, and FIG. 10D is an elevation view of a butt end surface of the plastic-worked lumber according to the embodiment of the present invention.

FIG. 11 is a characteristic diagram showing hardness of plastic-worked lumber according to the embodiment of the present invention as compared with comparative examples.

FIG. 12 is a characteristic diagram showing abrasion depth to be an index of abrasion resistance of plastic-worked lumber according to the embodiment of the present invention as compared with comparative examples.

FIG. 13 is Table showing values on air-dried specific gravity, hardness, abrasion depth and bending Young's modulus of plastic-worked lumber according to the embodiment of the present invention as compared with comparative examples.

FIG. 14A is a microphotograph (500-power) showing an enlarged part of lumber before processing to be a material used to form plastic-worked lumber according to the embodiment of the present invention, and FIG. 14B is a microphotograph (500-power) showing an enlarged part of the plastic-worked lumber according to the embodiment of the present invention.

FIG. 15 is a microphotograph (50-power) showing an enlarged part of plastic-worked lumber that is compressed so as to have air-dried specific gravity 1.3 times as much as that of lumber before heating and compression.

### DETAILED DESCRIPTION OF THE INVENTION

A preferred embodiment of the present invention is described hereafter referring to drawings. Here, the same reference marks and the same reference signs denote the same or similar parts and functions as those in the present embodiment, and overlapping description thereof will be omitted here.

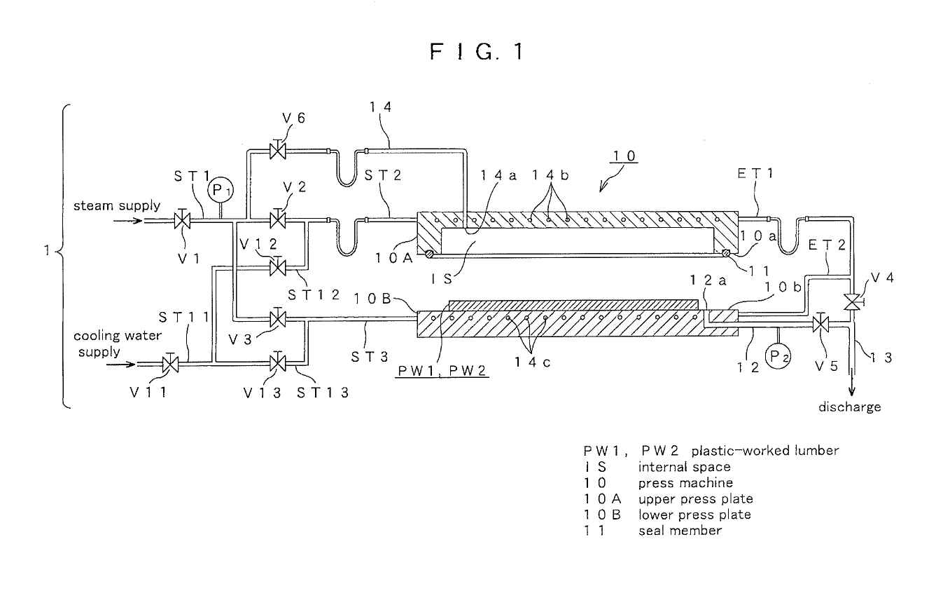

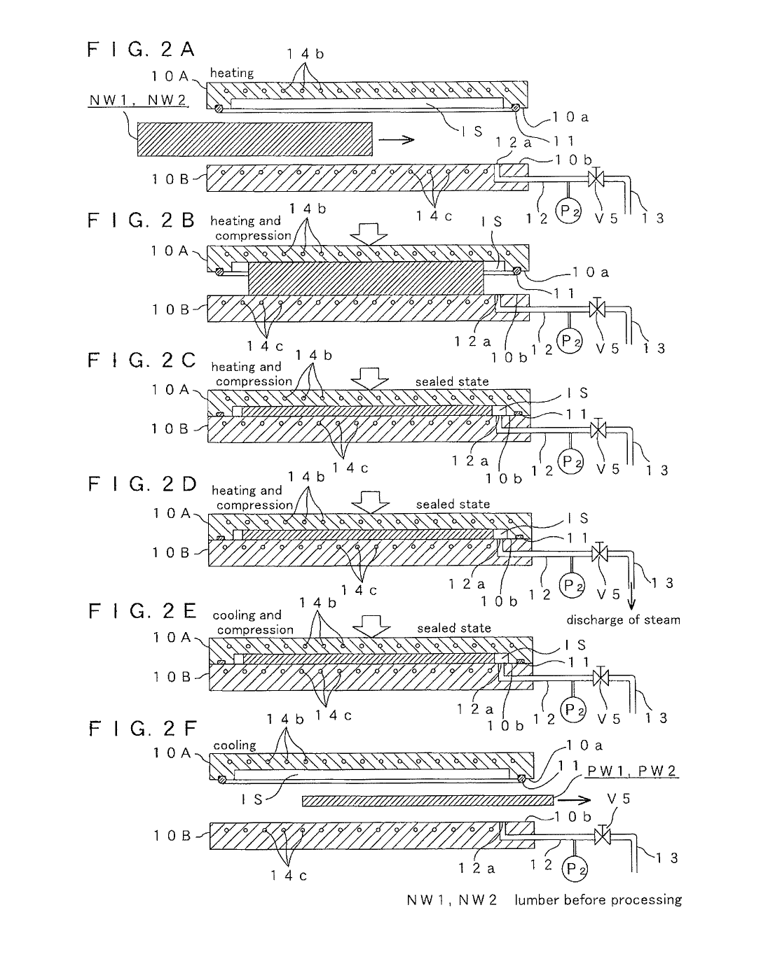

First, a process for manufacturing plastic-worked lumber PW1 or PW2 according to an embodiment of the present invention is described referring to FIGS. 1 and 2.

In FIG. 1, a plastic-worked lumber manufacturing apparatus 1 to manufacture plastic-worked lumber PW1 and PW2 according to an embodiment of the present invention mainly comprises: a press machine 10 having a structure divided into an upper press plate 10A and a lower press plate 10B, the upper press plate 10A and the lower press plate 10B forming an internal space IS; a seal member 11 placed on a peripheral portion 10a of the upper press plate 10A, the peripheral portion 10a facing a peripheral portion 10b of the lower press plate 10B, the lower press plate 10B making the internal space IS sealed in a range of a prescribed up-and-down movement of the upper press plate 10A; a pipe 12 formed so as to connect a lateral side of the lower press plate 10B and the internal space IS, the pipe 12 having a piping port 12a for discharging steam from the internal space IS; a pressure gauge P2 for detecting steam pressure inside the pipe 12; a valve V5 placed at a lower reach of the pipe 12; a drainpipe 13 connected to the valve 5; a piping port 14a for supplying steam to the internal space IS through a pipe 14, the piping port 14a formed in the upper press plate 10A, the pipe 14 connected to a valve 6; and the like.

In addition, pipelines 14b and 14c for raising temperature in the upper press plate 10A and the lower press plate 10B to a desired temperature by running high-temperature steam through the pipelines are formed in the upper press plate 10A and the lower press plate 10B, respectively. The pipeline 14b is connected to pipes ST2 and ET1 and the pipeline 14c is connected to pipes ST3 and ET2. The pipes ST2 and ST3 are branched from a pipe ST1 located on a supply side of steam. The pipes ET1 and ET2 are located on a discharge side of steam. Moreover, valves V1, V2, and V3 and a pressure gauge P1 for detecting steam pressure in the pipe ST1 are placed in the middle of the pipes ST1, ST2, and ST3 located on the supply side of steam. The pipes ET1 and ET2 located on the discharge side of steam are connected to the drainpipe 13 through a valve 4. In addition, a boiler for supplying steam to the pipe ST1 and a press lifting and lowering device having a hydraulic mechanism for applying pressure by lifting and lowering the upper press plate 10A against the lower press plate 10B that of a fixed side of the press machine 10 are omitted here. In the present embodiment, in order to heat the internal space IS that is formed by the upper press plate 10A and the lower press plate 10B of the press machine 10, high-temperature steam is introduced by using the pipe 14 that is connected to a valve V6. However, high-frequency heating, microwave heating, and the like may be used instead. In particular, as a process of high-frequency heating applied to lumber, a process for heating lumber from a center portion thereof with high-frequency wave that is slightly lower than microwave is preferable to induction heating with microwave.

Moreover, in the press machine 10, pipes ST12 and ST13 for cooling temperature in the press machine 10 to a desired temperature by running steam that is converted from low-temperature cooling water through the pipe lines 14b and 14c are connected to the pipes ST2 and ST3, respectively. The pipes ST12 and ST13 are branched from a pipe ST11 in a supply side of cooling water and the pipe lines 14b and 14c are formed in the upper press plate 10A and the lower press plate 10B, respectively. valves V11, V12, and V13 are placed in the middle of the pipes ST11, ST12, and ST13 on the supply side of cooling water. In addition, a device for supplying cooling water to the pipe ST11 is omitted in FIGS. 1 and 2.

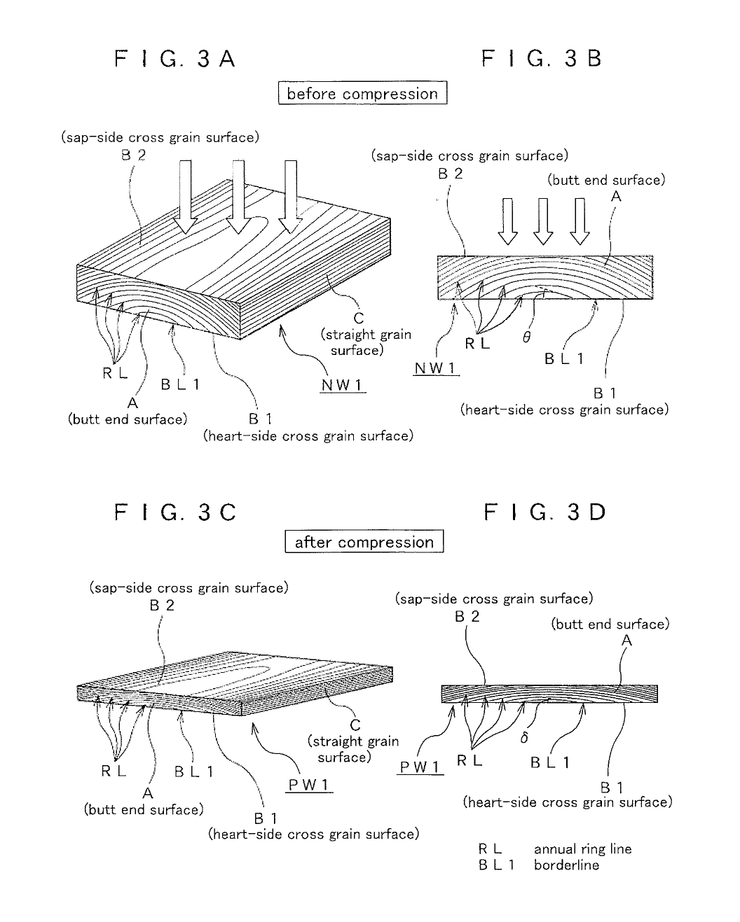

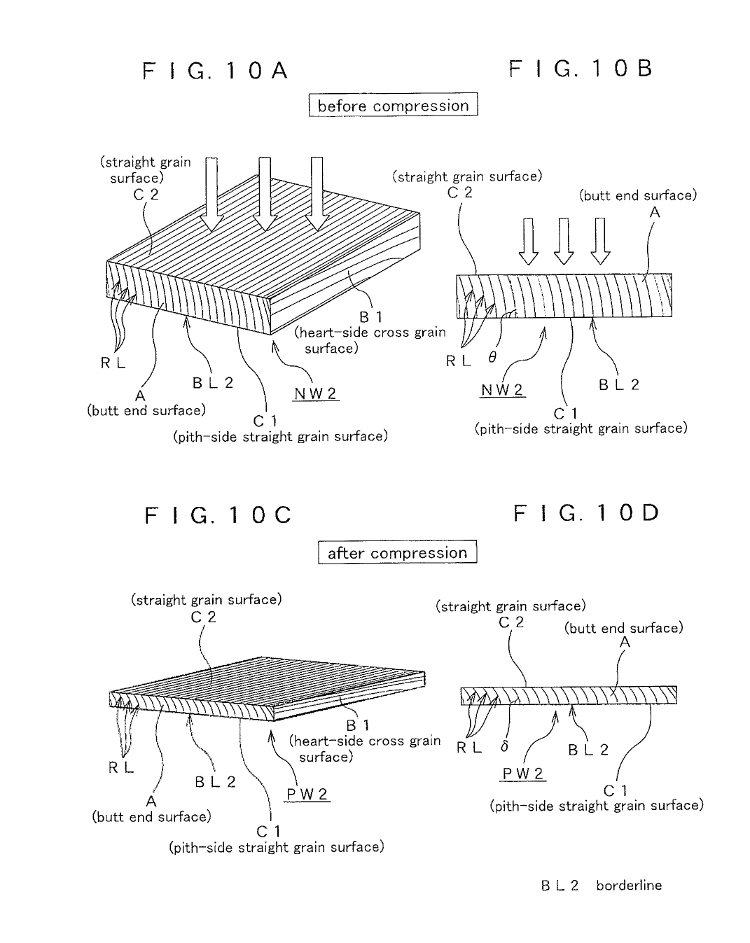

Here, as shown in FIGS. 3A, 3B, 10A, and 10B, lumber before processing NW1 or NW2 to be a material of plastic-worked lumber PW1 or PW2 according to the present embodiment is cut into a predetermined size (thickness, width, length) in advance, including two butt end surfaces, two cross grain surfaces (sap side, heart side) and two straight grain surfaces.

More specifically, as shown in FIGS. 3A and 3B, lumber before processing NW1 is selectively extracted from prepared cross-grained lumber that normally has every acute crossing angle θ within a range of 0 to 45 degrees. All of the acute crossing angles θ are formed by a borderline BL1 between a butt end surface A and a heart-side cross grain surface B1 of the lumber and annual ring lines RL on the butt end surface A of the lumber. Lumber before processing NW1 made of the cross-grained lumber thus prepared is plastically worked to form plastic-worked lumber PW1 according to the present embodiment.

In addition, as shown in FIGS. 10A and 10B, lumber before processing NW2 is selectively extracted from prepared straight-grained lumber that has normally has every acute crossing angle θ within a range of 45 to 90 degrees. All of the acute crossing angles θ are formed by a borderline BL2 between a butt end surface A and a heart-side straight grain surface B1 of the lumber and annual ring lines RL on the butt end surface A of the lumber. Lumber before processing NW2 made of the straight-grained lumber thus prepared is plastically worked to form plastic-worked lumber PW2 according to the present embodiment.

As described hereinafter, in order to prevent a crack caused by heating and compression, straight-grained lumber that has every acute crossing angle θ within a range of 45 to 85 degrees is used as lumber before processing NW2. All of the acute crossing angles θ are formed by a borderline BL2 between a butt end surface A and a pith-side straight grain surface C1 of the straight-grained lumber and annual ring lines RL on the butt end surface A of the straight-grained lumber.

Here, acute crossing angles θ and δ formed by a borderline BL1 on a heart-side cross grain surface B1 of lumber before processing NW1 and annual ring lines RL of the lumber before processing NW1 or formed by a borderline BL2 on a pith-side straight grain surface C1 of lumber before processing NW2 and annual ring lines RL of the lumber before processing NW2 are detected as acute crossing angles θ and δ formed by all of annual ring lines RL on the butt end surface and imaginary borderlines drawn in a range of 2 mm or less of the heart-side cross grain surface B1 located on pith side of lumber or the pith-side straight grain surface C1 along the pith-side cross grain surface B1 or the pith-side straight grain surface C1. However, in order to simplify its explanation, the said acute crossing angles θ and δ are treated as angles with a heart-side cross grain surface B1 or a pith-side straight grain surface C1. Even if thus treated and if crossing angles θ and δ with the heart-side cross grain surface B1 or the pith-side straight grain surface C1 are treated as acute crossing angles θ and δ formed by annual ring lines RL on a heart-side cross grain surface B1 or a pith-side straight grain surface C1 and imaginary borderlines drawn in a range of 2 mm or less of the heart-side cross grain surface B1 or the pith-side straight grain surface C1 along the heart-side cross grain surface B1 or the pith-side straight grain surface C1, only a slight difference is occurred.

When making plastic-worked lumber PW1 from lumber before processing NW1 shown in FIG. 3 or making plastic-worked lumber PW2 from lumber before processing NW2 shown in FIG. 10 by using the plastic-worked lumber manufacturing apparatus 1 thus formed, the upper press plate 10A is first lifted against the lower press plate 10B that is the fixed side of the press machine 10 as shown in FIG. 2A. Then, lumber before processing NW1 or NW2 that is dried in advance so as to meet prescribed conditions is placed in the internal space IS that is formed by the upper press plate 10A and the lower press plate 10B.

In addition, in the present embodiment, a heart-side cross grain surface B1 shown in FIGS. 3A and 3B is placed on the lower press plate 10B of the press machine 10. In the practice of the present invention, a sap-side cross grain surface B2 may be placed on the lower press plate 10B instead.

On the other hand, in the present embodiment, a pith-side straight grain surface C1 shown in FIGS. 10A and 10B is placed on the lower press plate 10B of the press machine 10 in case of lumber before processing NW2 made of straight grain lumber. In the practice of the present invention, a straight grain surface C2 may be placed on the lower press plate 10B instead.

Subsequently, as shown in FIG. 2B, the upper press plate 10A is lowered against the lumber before processing NW1 or NW2 that is placed on the fixed lower press plate 10B at prescribed pressure to make an upper surface of the lumber before processing NW1 or NW2, which is a sap-side cross grain surface B1 in case of the lumber before processing NW1 and a straight grain surface C2 on a side opposite to a pith-side straight grain surface C1 in case of the lumber before processing NW2 in the present embodiment, and the upper press plate 10A contact each other (refer to FIGS. 3A, 3B, 10A, 10B). The internal space IS is kept at prescribed temperature (e.g. 110 to 180 degrees) by running steam of prescribed temperature (e.g. 110 to 160 degrees) through the pipe lines 14b and 14c that are formed in the upper press plate 10A and the lower press plate 10B, respectively.

Next, as shown in FIG. 2C, compression pressure exerted by the upper press plate 10A on the fixed lower press plate 10B is set at prescribed pressure (e.g. 2 to 5 MPa). Then, lumber before processing NW1 or NW2 is heated and compressed with the upper press plate 10A and the lower press plate 10B for a predetermined period of time (e.g. 5 to 40 minutes). Here, in order to prevent a crack, the compression pressure preferably increases gradually depending on a rise in temperature of the lumber before processing NW1 or NW2, namely a progress of transmission of temperature inside the lumber before processing NW1 or NW2. In addition, time for heating and compression is preferably set in consideration of transmission time.

Moreover, when the peripheral portion 10a of the upper press plate 10A and the peripheral portion 10b of the lower press plate 10B contact each other, the internal space IS formed by the upper press plate 10A and the lower press plate 10B is sealed by the seal member 11 that is placed on the peripheral portion 10a of the upper press plate 10A. The sealed internal space IS is heated to prescribed temperature (e.g. 150 to 210 degrees) while keeping the compression pressure exerted by the upper press plate 10A and the lower press plate 10B.

In addition, in the present embodiment, a vertical dimension of an internal space IS is set at a finished dimension in a thickness direction of plastic-worked lumber PW1 in the case of making lumber before processing NW1 plastically worked. The internal space IS is formed by the upper press plate 10A and the lower press plate 10B of the press machine 10 and sealed via the seal member 11. The lumber before processing NW1 is plastically worked with the press machine 10 to form the plastic-worked lumber PW1. The plastic-worked lumber PW1 has every acute crossing angle δ within a range of 25 degrees or less. All of the acute crossing angles δ are formed by a pith-side borderline BL1 and annual ring lines RL. The borderline BL1 is a borderline between a butt end surface A and a heart-side cross grain surface B1 of the plastic-worked lumber PW1

In addition, when lumber before processing NW2 is plastically worked, a vertical dimension of the internal space IS that is sealed via the seal member 11 is set in advance at a finished dimension in a thickness direction of plastic-worked lumber PW2 so that plastic-worked lumber PW2 is formed so as to have every acute crossing angle δ within a range of 45 degrees or less formed by a pith-side borderline BL2 and annual ring lines of the plastic-worked lumber PW2. The pith-side borderline BL2 is a borderline between a butt end surface and a pith-side straight grain surface C1.

Therefore, a change in acute crossing angle θ of lumber before processing NW1 depends on contact of the peripheral portion 10a of the upper press plate 10A with the peripheral portion 10b of the lower press plate 10B. The acute crossing angles θ are formed by a pith-side borderline BL1 between a butt end surface A and a heart-side cross grain surface B1 of the lumber and annual ring lines RL on the butt end surface A. The change in the acute crossing angle θ is caused by compressing the lumber before processing NW1. In addition, a change in acute crossing angle θ of lumber before processing NW2 also depends on contact of the peripheral portion 10a of the upper press plate 10A with the peripheral portion 10b of the lower press plate 10B. The change in the acute crossing angle θ is caused by compressing the lumber before processing NW2. The acute crossing angles θ are formed by a pith-side borderline BL2 between a butt end surface A and a pith-side straight grain surface C1 of the lumber and annual ring lines RL on the butt end surface A.

Moreover, as shown in FIG. 2C, while the internal space IS is in a sealed state, compression pressure exerted by the upper press plate 10A and the lower press plate 10B is maintained and temperature in the internal space IS is kept at prescribed temperature (e.g. 150 to 210 degrees) for a prescribed period of time (e.g. 30 to 120 minutes). Heating and compression are performed to form plastic-worked lumber PW1 or PW2 that does not return to its original shape after releasing cooling and compression. Here, high-temperature and high-pressure steam is free to move in and out of a peripheral surface of lumber before processing NW1 or NW2 and an inner portion thereof through the internal space IS. The internal space IS is sealed by the upper press plate 10A and the lower press plate 10B.

As described above, in the present embodiment, both surfaces of lumber before processing NW1 or NW2 have contact with the upper press plate 10A and the lower press plate 10B and kept in the sealed internal space IS. Thereby, the lumber before processing NW1 or NW2 is sufficiently heated and efficiently deformed entirely in a thickness direction thereof.

Next, as shown in FIG. 2D, while heating and compression are performed with the sealed internal space IS, steam pressure in the internal space IS is detected with a pressure gauge P2 and a valve V5 is opened and closed accordingly as a process for controlling the steam pressure. Thereby, extra water in the internal space IS based on water content of an outer layer portion of lumber before processing NW1 or NW2 is especially eliminated and the internal space IS may be controlled so as to have predetermined steam pressure when high temperature and high pressure steam is discharged from the internal space IS toward a drainpipe 13 through a piping port 12a and a pipe 12, In addition, prescribed steam pressure can be supplied as needed to the internal space IS through a pipe 14 that is connected to a valve 6 and a piping port 14a (FIG. 1).

Furthermore, just before shifting from a process of heating and compression to a process of cooling and compression with the upper press plate 10A and the lower press plate 10B, the valve 5 is opened as a process for controlling steam pressure. Thereby, high temperature and high pressure steam is discharged from the internal space IS toward the drainpipe 13 through the piping port 12a and the pipe 12. Therefore, establishment of a process for heating and compressing lumber, or so-called fixing of lumber may be further promoted.

Subsequently, as shown in FIG. 2E, the upper press plate 10A and the lower press plate 10B are cooled to around room temperature and kept for a prescribed period of time (e.g. 10 to 20 minutes) by running room-temperature cooling water through the pipe lines 14b and 14c. The prescriber period of time depends on a material. The pipe lines 14b and 14c are formed in the upper press plate 10A and the lower press plate 10B, respectively. Here, while compression pressure of the upper press plate 10A on the fixed lower press plate 10B is maintained at prescribed pressure that is the same as pressure exerted in heating and compression (e.g. 2 to 5 MPa), the upper press plate 10A and the lower press plate 10B are cooled.

And finally, as shown in FIG. 2F, when the upper press plate 10A is lifted against the fixed lower press plate 10B to take out plastic-worked lumber PW1 or PW2 as a finished product from the internal space IS, a series of process is complete.

As described above, in the present embodiment, steam pressure is controlled and gradually released to release internal steam pressure. In addition, steam pressure inside lumber is lowered and fixed by cooling. Thereby, it is possible to form plastic-worked lumber PW1 or PW2 that does not have a swelling deformation or a surface crack, which is so-called puncture, when cooling and compression are released. That is, plastic-worked lumber PW1 or PW2 according to the present embodiment may not have a swelling deformation or a surface crack after releasing compression and a stable quality may be ensured.

In the present embodiment, plastic-worked lumber PW1 or PW2 is provided by compressing and fixing lumber with the upper press plate 10A and the lower press plate 10B. However, in the practice of the present invention, plastic-worked lumber PW1 or PW2 may be provided even if lumber before processing NW1 or NW2 is heated and compressed and fixed by high frequency induction heating that is slightly lower than a microwave frequency band to be used by a normal microwave oven

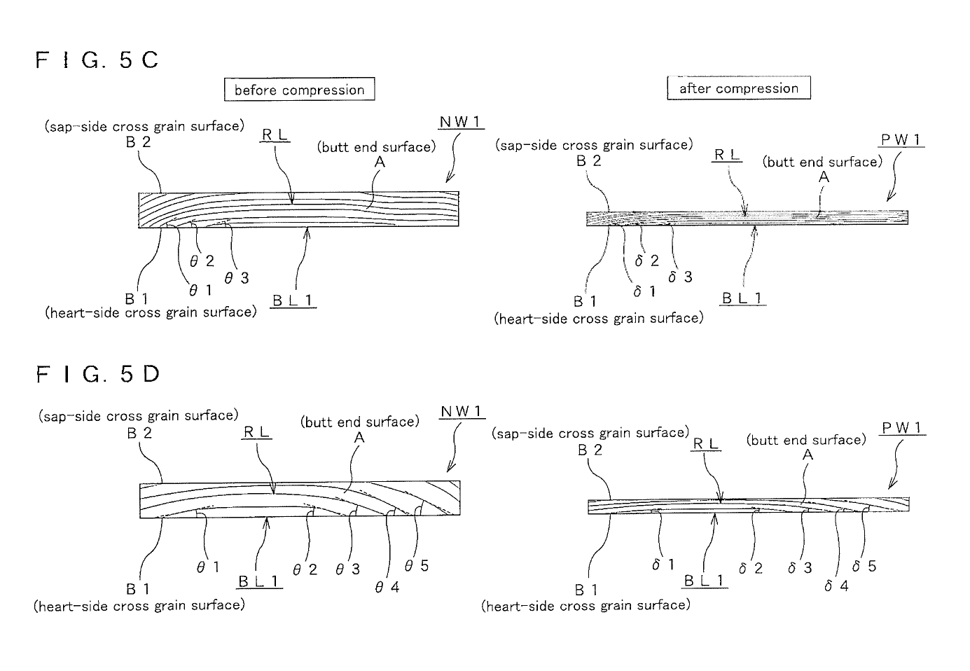

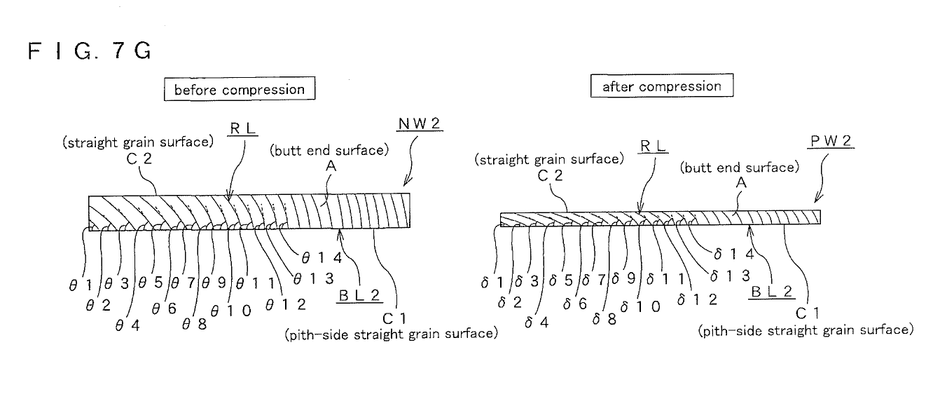

Next, plastic-worked lumber PW1 or PW2 according to the present embodiment formed as mentioned above is described referring to FIGS. 3 to 13.

As shown in FIGS. 3 and 10, annual ring lines RL on a but end surface A of lumber are often curved in a center side of the annual ring lines RL, namely in the vicinity of intersection of a pith-side borderline BL1 or BL2 and the annual ring lines. In addition, when the upper press plate 10A is lowered against the lower press plate 10B on which a heart-side cross grain surface B1 of lumber before processing NW1 or a pith-side straight grain surface C1 of lumber before processing NW2 is placed and then heating and compression are performed, annual ring lines RL on lower side of a butt end surface A (those close to a heart-side cross grain surface B1 of plastic-worked lumber PW1 according to the present embodiment, those close to a pith-side straight grain surface C1 of plastic-worked lumber PW2 according to the present embodiment) normally tend to have an increased bending deformation or an increased buckling deformation. Variation in measurement may arise therein. Thereby, acute crossing angles θ and δ originally should be a value obtained by drawing a line from the pith-side borderline BL1 or BL2 along annual ring lines RL on a butt end surface A to a point on pith-side annual ring lines RL that is about 1 to 2 mm away from the borderline BL1 or BL2 to measure angles between corresponding tangent lines and the borderline BL1 or BL2.

That is, to be exact, acute crossing angles formed by all of annual ring lines RL on a butt end surface A of lumber and imaginary borderlines drawn in a range of 2 mm or less of a pith-side cross grain surface B1 or a pith-side straight grain surface C1 as viewed from the butt end surface A along the pith-side cross grain surface B1 or the pith-side straight grain surface C1 should be crossing angles θ or δ. However, in order to simplify its explanation, acute crossing angles θ or δ formed by a pith-side borderline BL1 or BL2 and annual ring lines RL on a butt end surface A will be hereafter described instead.

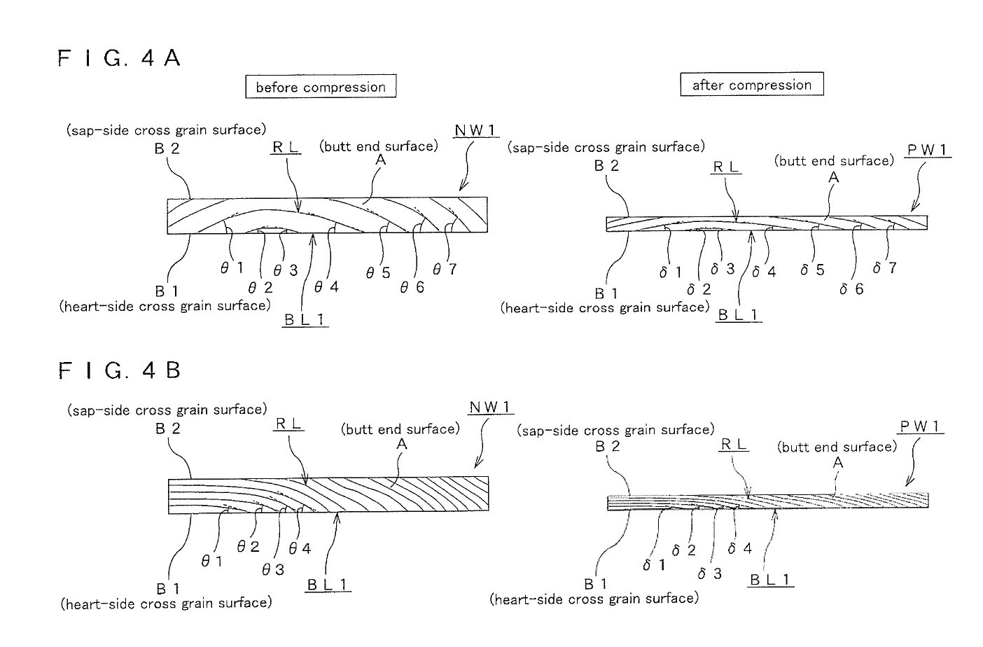

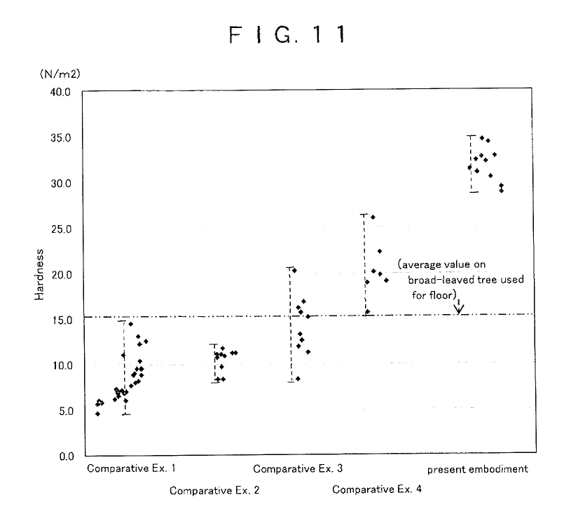

Here, the present inventors pay attention to the fact that as lumber before processing NW1 is compressed in a vertical direction of a cross grain surface B1 or B2 of the lumber, acute crossing angles θ gradually decrease. The acute crossing angles θ are formed by a pith-side borderline BL1 between a heart-side cross grain surface B1 and a butt end surface A of the lumber and annual ring lines RL on the butt end surface A. It is found that when heating and compression are applied above a specific level to the lumber before processing NW1, the lumber after heating and compression has the following advantages as shown in FIGS. 11 to 13: it is physically stable with a reduced variation in characteristic values such as hardness of lumber and abrasion depth to be an index of abrasion resistance; and it has a significant increase in hardness and tends not to have a flaw or a dent. In addition, acute crossing angles δ formed by the pith-side borderline BL1 and annual ring lines RL on the butt end surface A of the lumber after compression are measured when the lumber is physical stable and has hardness that begins to increase significantly. As in examples shown in FIGS. 4 to 6E and FIG. 8, plastic-worked lumber PW1 has every acute crossing angle δ within a range of 0 to 25 degrees. The plastic-worked lumber PW1 is made of cross-grained lumber.

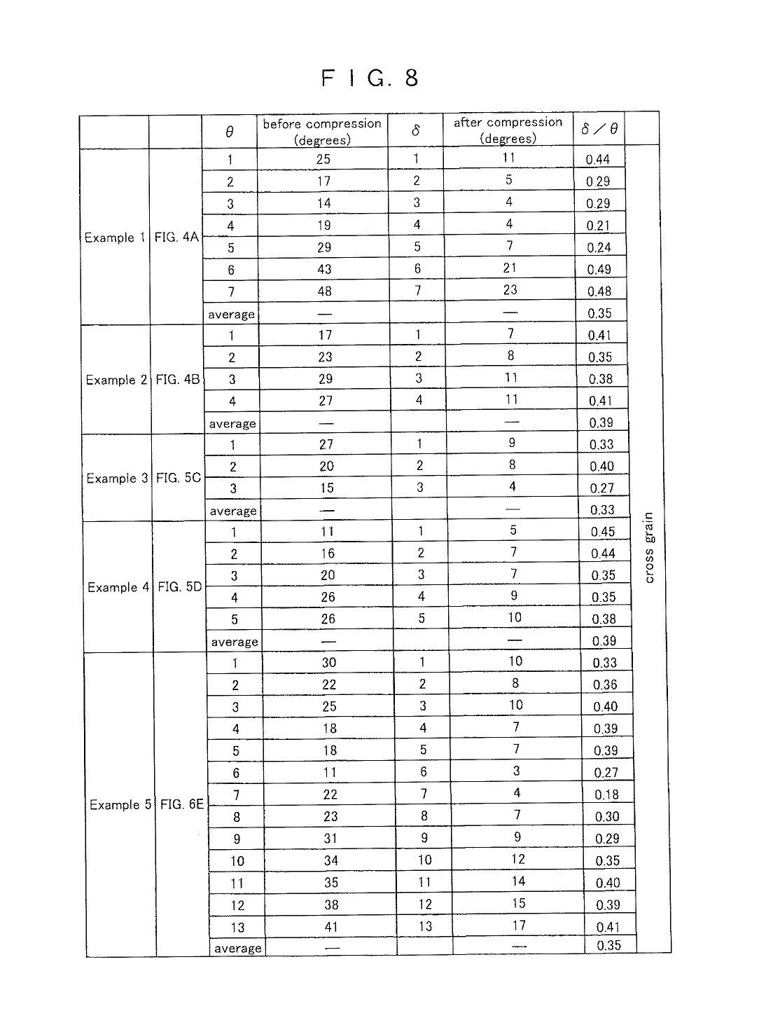

Examples of cross-grained lumber shown in FIGS. 4 to 6E and FIG. 8 illustrate plastic-worked lumber PW1 that is physically stable and has hardness that begins to increase significantly. In addition, every acute crossing angle δ within a range of 0 to 25 degrees is obtained as follows. As shown in FIG. 8, acute crossing angles θ of cross-grained lumber that is normally in the market place are within a range of approximately 0 to 45 degrees. When the cross-grained lumber is compressed so as to be physically stable and have hardness that begins to increase significantly, acute crossing angles of the lumber are obtained by experiment and studies and relatively determined against the crossing angles θ before compression.

In addition, as shown in FIG. 8, acute crossing angles δ after compression formed by a pith-side borderline BL1 between a heart-side cross grain surface B1 and a butt end surface A and annual ring lines RL on the butt end surface A are 0.5 times or less than relevant/said acute crossing angles θ before compression based on arithmetic mean of angles in whole lumber. That is, crossing angles δ after heating and compression divided by relevant/said/corresponding crossing angles θ before heating and compression is ½ or less based on the arithmetic mean of angles in the whole lumber. The value is substantially proportional to a change in Tan⁻¹θ and Tan⁻¹δ, which is practically close to a change in air-dried specific gravity.

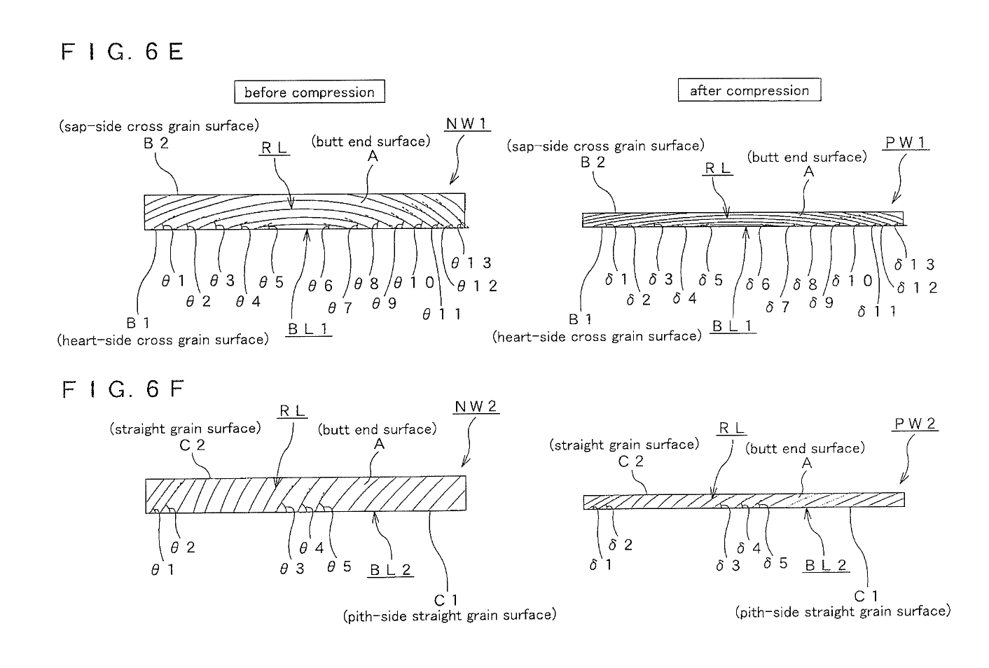

Moreover, the present inventors pay attention to the fact that as heating and compression are applied to lumber before processing NW2 in a vertical direction of a straight grain surface C1 or C2 of the lumber with the upper press plate 10A and the lower press plate 10B, acute crossing angles θ formed by a pith-side borderline BL2 between a pith-side straight grain surface C1 and a butt end surface A of the lumber and annual ring lines RL on the butt end surface A gradually decrease. It is found that when heating and compression are applied above a specific level to lumber, the lumber has the following advantages as shown in FIGS. 11 to 13: the lumber is physically stable with a reduced variation in characteristic values such as hardness of lumber and abrasion depth to be an index of abrasion resistance; and the lumber has a significant increase in hardness and tends not to have a flaw or a dent. Then, acute crossing angles obtained when lumber is physically stable and has hardness that begins to significantly increase are measured. As in examples shown in FIGS. 6F, 7, and 9, plastic-worked lumber PW2 has every acute crossing angle δ that is within a range of 15 to 45 degrees. The plastic-worked lumber PW2 is made of straight-grained lumber.

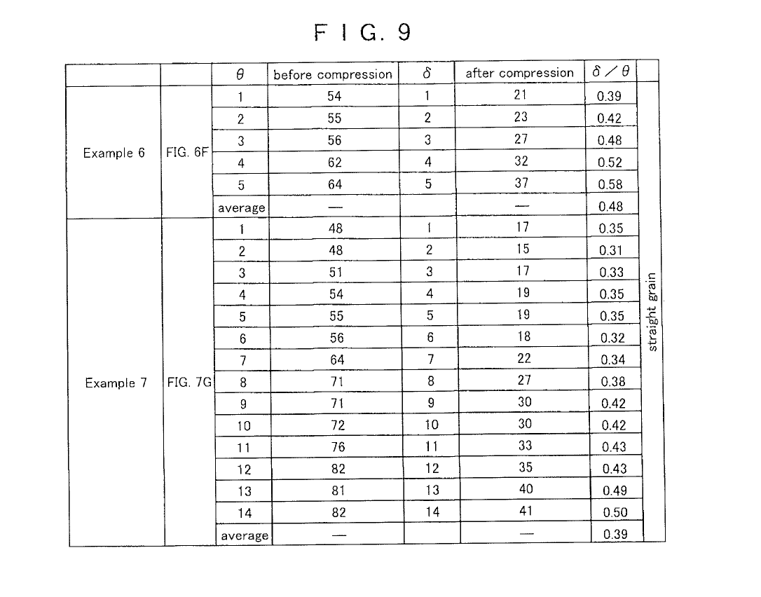

Examples shown in FIG. 6F, 7 and 9 illustrate plastic-worked lumber 2 that is physically stable and has hardness that begins to significantly increase. In addition, plastic-worked lumber that has every acute crossing angle δ within a range of 15 to 45 degrees is obtained as follows. As shown in FIG. 9, acute crossing angles θ of lumber before processing NW2 made of straight-grained lumber before compression that is normally in the market place are within a range of approximately 45 to 90 degrees. The lumber is compressed until it is physically stable and has hardness that begins to significantly increase. Here, acute crossing angles δ of the lumber after compression are obtained by experiment and studies and relatively determined against crossing angles θ before compression.

Moreover, as shown in FIG. 9, acute crossing angles δ after compression formed by a pith-side borderline BL2 between a pith-side straight grain surface C1 and a butt end surface A and annual ring lines RL on the butt end surface A are 0.5 times or less than corresponding acute crossing angles θ before compression based on an arithmetic mean of a whole lumber's angles. That is, crossing angles δ after heating and compression divided by the corresponding crossing angles θ before heating and compression is ½ or less based on an arithmetic mean of a whole lumber's angle. The value thereof is substantially proportional to a change in Tan⁻¹θ and Tan⁻¹δ. However, that is practically close to a change in air-dried specific gravity.

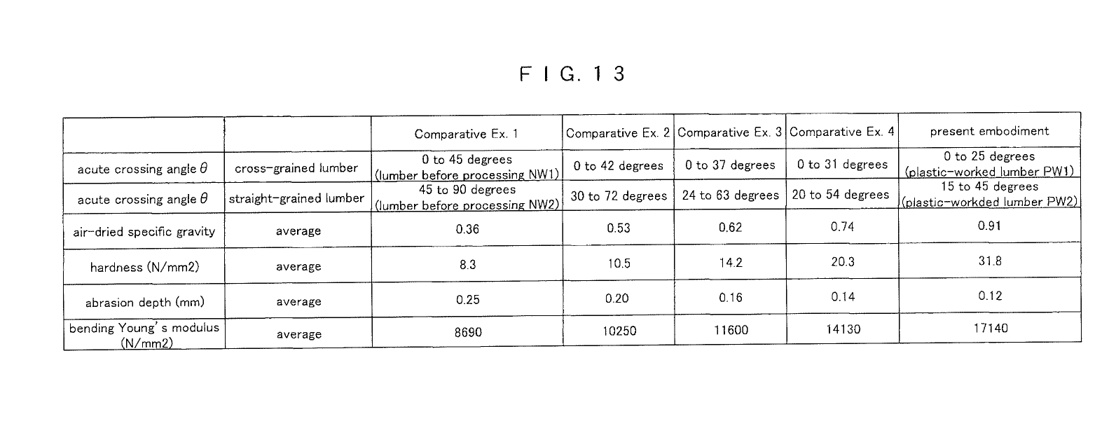

Here, according to the experiment by the present inventors, it is confirmed that cross-grained lumber having acute crossing angles δ that are 0.5 times or less than those of the cross-grained lumber before compression based on an arithmetic mean of the whole lumber's angles has air-dried specific gravity twice or more than that of the cross-grained lumber before compression. The acute crossing angles δ is formed by a pith-side borderline BL1 between a heart-side cross grain surface B1 and a butt end surface A of the cross-grained lumber and annual ring line RL on the butt end surface A of the cross-grained lumber. In addition, straight grain lumber having acute crossing angles δ that are 0.5 times or less than those of the straight-grained lumber before compression based on an arithmetic mean of the whole lumber's angles has air-dried specific gravity twice or more than that of the straight-grained lumber before compression also has air-dried specific gravity twice or more than that of the cross-grained lumber before compression. The acute crossing angles δ are formed by a borderline BL2 between a pith-side straight grain surface C1 and a butt end surface A of the straight-grained lumber and annual ring lines RL on the butt end surface A of the straight-grained lumber. (refer to FIG. 13).

Therefore, the plastic-worked lumber PW1 and PW2 according to the present embodiment is formed by applying external force to lumber before compression NW1 and NW2 so that the lumber before compression NW1 and NW2 is heated and compressed in a thickness direction thereof and plastically worked, wherein lumber after heating and compression has air-dried specific gravity twice or more than that of the lumber before heating and compression and acute crossing angles within a range of 45 degrees or less. The acute angles are formed by all of annual ring lines RL on a butt end surface A of the lumber after heating and compression and imaginary borderline drawn in a range of 2 mm or less of a pith-side cross grain surface B1 or a pith-side straight grain surface C1 as viewed from the butt end surface A of the lumber after heating and compression along the pith-side cross grain surface B1 or the pith-side straight grain surface C1 of the lumber after heating and compression.

According to experiment and studies by the present inventors, when plastic-worked lumber PW2 is manufactured by using lumber before processing NW2 having acute crossing angles θ of more than 85 degrees, a resultant plastic-worked lumber PW2 has an increased bending deformation of annual ring lines RL and may have a crack in some cases. The acute crossing angles θ are formed by a pith-side borderline BL1 between a pith-side straight grain surface C1 and a butt end surface A of the plastic-worked lumber and annual ring lines RL on the butt end surface A of the plastic-worked lumber.

Therefore, lumber having every acute crossing angle θ within a range of 85 degrees or less is preferably used as lumber before processing NW2 made of straight-grained lumber to be a material of plastic-worked lumber PW2. All of the acute crossing angles θ are formed by a borderline BL2 between a pith-side straight grain surface C1 and a butt end surface A of the lumber and annual ring lines RL on the butt end surface A of the lumber. That is, lumber before compression to be a material of plastic-worked lumber PW2 preferably has every acute crossing angle θ of 85 degrees or less formed by a borderline BL2 between a pith-side straight grain surface C1 and a butt end surface A of the lumber before compression and annual ring lines RL on the butt end surface A of the lumber before compression. This may prevent a bending deformation of the annual ring lines and a crack due to heating and compression. Thereby, a high quality may be ensured in the plastic-worked lumber PW2. Moreover, the lumber before compression more preferably has acute crossing angles of 60 degrees or less in that there is little possibility of having a crack.

Similarly, lumber having every acute crossing angle θ within a range of 0 to 45 degrees is preferably used as lumber before processing NW1 made of cross-grained lumber to be a material of plastic-worked lumber PW1. All of the acute crossing angles θ are formed by a borderline BL1 between a heart-side cross grain surface B1 and a butt end surface A of the lumber and annual ring lines RL on the butt end surface A of the lumber. That is, lumber before compression to be a material of plastic-worked lumber PW1 preferably has every acute crossing angle θ within a range of 0 to 45 degrees formed by a borderline BL1 between a heart-side cross grain surface B1 and a butt end surface A of the lumber before compression and annual ring lines RL on the butt end surface A of the lumber before compression. This may prevent a bending deformation of the annual ring lines RL and no crack due to heating may be occurred. Thereby, a high quality may be ensured in the plastic-worked lumber PW1.

That is, unless cross-grained lumber and straight-grained lumber are specified or if cross-grained lumber is partly seen, cross-grained lumber has a structure of straight-grained lumber. Thereby, lumber having every acute crossing angle θ within a range of 85 degrees or less formed by a pith-side borderline BL1 or BL2 annual ring lines RL is preferably used as lumber before processing NW1 or NW2, more preferably within a range of 60 degrees or less. The pith-side borderline BL1 is between a heart-side cross grain surface B1 and a butt end surface A of the lumber before processing NW1 and the borderline BL2 is between a pith-side straight grain surface C1 and a butt end surface A of the lumber before processing NW2.

In addition, plastic-worked lumber PW1 and PW2 preferably has every acute crossing angle δ within a range of 45 degrees or less formed by a borderline BL1 or BL2 and annual ring lines RL of a butt end surface A of the plastic-worked lumber.

In the present embodiment, cedar wood that has average air-dried specific gravity of approximately 0.36 before procession is used as lumber before processing NW1 or NW2 that forms plastic-worked lumber PW1 or PW2. Plastic-worked lumber PW1 and PW2 is made of cedar wood. Cedar wood is readily available and processed. Thereby, when cedar wood is used as plastic-worked lumber PW1 or PW2, productivity may be improved with cost reduction and a demerit of cedar wood may be covered. Especially, cedar wood that is referred to as “obisugi” in Japanese may be the most suitable in that it grows in a short period of time and is available in large amounts. Moreover, cedar wood is widely distributed in Japan and thinning and the like are available in large amounts. Thereby, when cedar wood is used as plastic-worked lumber PW1 or PW2, it may lead to a contribution in environmental protection.

In the practice of the present invention, not only cedar wood but also pine, Japanese cypress, Yellow Poplar and the like may be used instead. Pine and a Japanese cypress are widely distributed in Japan and thinning and the like are readily available in large amounts. In addition, pipe and Japanese cypress are readily processed, thereby obtaining the same effect as in the case of using cedar wood. In addition, yellow poplar (scientific name: Liriodendron tulipifera, which is also referred to as hantenboku, tulip poplar, canary whitewood or liriodendron), eucalyptus, Acacia mangium, falcataria, malapapaya, yellow poplar, eaglewood, rubber tree, Gmelina, poplar, Radiata pine, and Merkusii pine are readily available and processed like a Japanese cedar, thereby allowing productivity to be improved and reducing cost of production. In particular, yellow poplar originally has a light color and may change in color depending on a material. However, deepening or blacking of yellow poplar due to high compression is generally controlled and excellent appearance may be maintained.

In addition, sapwood is preferably used as lumber before processing NW1 or NW2 for forming plastic-worked lumber PW1 or PW2 in that an amount of resin that comes to a surface of lumber when it is compressed and deepening of the lumber due to high compression may be controlled while keeping an excellent appearance.

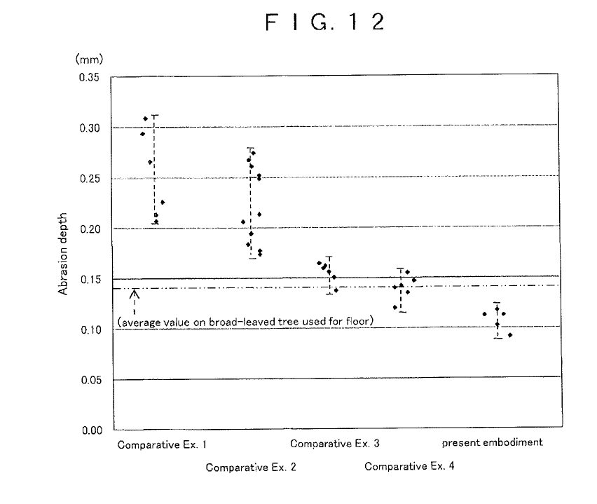

Subsequently, physical properties of plastic-worked lumber PW1 or PW2 according to the present embodiment are described in detail referring to FIGS. 11 to 15 while making comparisons with comparative examples. Comparative Examples shown in FIGS. 11 and 12 correspond to those shown in Table in FIG. 13. Each value in air-dried specific gravity, hardness, abrasion depth, and bending Young's modulus according to the present embodiment shown in Table in FIG. 13 shows an average value on plastic-worked lumber PW1 or PW2 that is physically stable and has hardness that begins to significantly increase as examples shown in FIGS. 4 to 7.

Here, hardness (N/mm²) shown in FIGS. 11 and 13 is evaluated according to JIS-Z-2101-1994. Specifically, a steel ball of 10 mm in diameter is pressed into a surface of lumber (a cross grain surface B1 or B2 in the case of plastic-worked lumber PW1, a straight grain surface C1 or C2 in the case of plastic-worked lumber PW2) at an average speed of 0.5 mm/min. When a press-in depth is 0.32 mm, a load P (N) is measured to calculate the hardness with the following formula (1): hardness H=P/10.

The experiment and studies by the present inventors indicate that a broad-leaved tree (such as oak) that is used as a floor material normally has a hardness of approximately 15 N/mm². Thereby, lumber that has a hardness of 25 N/mm² or more is enough to be used as a floor material and the like and may be used in a wide range of applications. The floor material and the like are readily subject to a concentrated load or a shock load and require a high surface hardness. In addition, the value of 25 N/mm² shall not require the exact value of 25 N/mm² as long as it is approximately 25 N/mm².

The value of 25 N/mm² is an approximate value including an error and a small percentage of errors are embraced therein.

In addition, abrasion depth (mm) shown in FIGS. 12 and 13 to be an index of abrasion resistance is evaluated according to JIS-Z-2101-1994. Specifically, a weight of lumber m₂ (g) is measured with a so-called abrasion tester when a load to be applied to lumber is set at approximately 5.2 N to rotate the lumber and an abrasion wheel 500 times at a rotation speed of approximately 60 rpm. A weight m₁ (g) of the lumber before the test, an area A (mm²) of a portion that is abraded by the abrasion wheel, and a density p (g/cm³) are used to measure the abrasion depth with the following formula (2): abrasion depth D=(m₁−m₂)/A·ρ.

Moreover, bending Young's modulus (N/mm²) to be an index of stiffness shown in FIG. 13 is evaluated according to JIS-Z-2101. Specifically, a two-point load test is used to calculate it from the following formula: E_{b}=ΔP·L3/48·I·Δy. Signs as used herein are described below.
E_{b}: bending Young's modulus (N/mm²) (Kgf/cm²)
ΔP: a difference between a maximum load and a minimum load in a proportional region
Δy: deflection in a center portion of a span corresponding to ΔP.
I: second moment of area; I=bh³/12 (mm⁴)
L: a span (mm)
b: a width of specimen (mm)
h: a height of specimen (mm)

The experiment and studies by the present inventors indicate that a broad-leaved tree (such as oak) that is used as a floor material normally has abrasion depth of approximately 0.14 mm. Thereby, lumber that has abrasion depth of 0.12 mm or less is enough to be used as a floor material and may be used in a wide range of applications. The floor material and the like are readily subject to a concentrated load or a shock load and require a high surface hardness. In addition, the value of 0.12 mm shall not require the exact value of 0.12 mm as long as it is approximately 0.12 mm. The value of 0.12 mm is an approximate value including an error and a small percentage of errors are embraced therein.

As shown in FIGS. 11 to 13, plastic-worked lumber PW1 or PW2 according to the present embodiment is significant high in hardness (N/mm²) and bending Young's modulus (N/mm²) as compared with comparative examples. In addition, plastic-worked lumber PW1 or PW2 according to the present embodiment is very low in abrasion depth (mm) as compared with comparative examples.

That is, FIG. 11 indicates that the heated and compressed lumber with a plastic working has excellent properties in hardness, abrasion resistance, and stiffness and tends not to have a flaw or a dent under the following conditions. The lumber is formed so as to have air-dried specific gravity twice or more than that of the lumber before heating and compression and acute crossing angles within a range of 45 degrees or less. The acute crossing angles are formed by all of annual ring lines RL on a butt end surface A of the lumber and imaginary borderlines drawn in a range of 2 mm or less of a pith-side cross grain surface B1 or a pith-side straight grain surface C1 as viewed from the butt end surface A along the pith-side cross grain surface B1 or the pith-side straight grain surface C1 of the lumber.

Especially, as shown in FIG. 11, the hardness (N/mm²) is remarkably high as compared with comparative examples. A broad-leaved tree (such as oak) that is used as a floor material normally has hardness of approximately 15 N/mm². Thereby, it is found that plastic-worked lumber PW1 and PW2 according to the present embodiment has enough hardness to use as a floor material and the like. The floor material and the like are readily subject to a concentrated load or a shock load and require a high hardness.

In addition, as shown in FIG. 12, a broad-leaved tree (such as oak) that is used for a floor material normally has abrasion depth of approximately 0.14 mm. Thereby, it is found that plastic-worked lumber PW1 and PW2 according to the present embodiment has enough abrasion resistance to use as a floor material and the like. The floor material and the like are readily subject to a concentrated load or a shock load and require a high abrasion resistance. Therefore, the plastic-worked lumber PW1 and PW2 according to the present embodiment tends not to have a flaw or a dent even if it is used as a floor material and the like that are readily subject to the concentrated load or the shock load. The plastic-worked lumber PW1 and PW2 may be used in a wide range of applications.

Moreover, as shown in FIGS. 11 and 12, comparative examples have large variations in hardness (N/mm²) and abrasion depth (mm). In contrast, plastic-worked lumber PW1 and PW2 according to the present embodiment has reduced variation as compared with the comparative examples under the following conditions. Lumber after heating and compression has air-dried specific gravity twice or more than that of the lumber before heating and compression and acute crossing angles within a range of 45 degrees or less. The acute crossing angles are formed by formed by all of annual ring lines RL on a butt end surface A of the lumber and imaginary borderlines drawn in a range of 2 mm or less of a pith-side cross grain surface B1 or a pith-side straight grain surface C1 as viewed from the butt end surface A of the lumber along the pith-side cross grain surface B1 or the pith-side straight grain surface C1 of the lumber. That is, the plastic-worked lumber PW1 and PW2 according to the present embodiment is physically stable and has less variation in quality among products.

Such difference between lumber before heating and compression and plastic-worked lumber may be caused by the following reasons. An early wood portion of lumber has a thin cell wall and a high porosity. Thereby, an arrangement of annual rings (early wood portion, late wood portion) may vary depending on lumber (unprocessed lumber before NW1, NW2). Lumber of comparative examples has locally deformed cells due to compression and may not be compressed averagely in overall thickness. In contrast, in the plastic-worked lumber PW1 and PW2 according to the present embodiment, an early wood portion has almost all cells that are deformed due to compression and cell walls overlap one another. The early wood portion may have an extreme reduction in porosity (in a cell cavity) and be compressed uniformly in overall thickness.

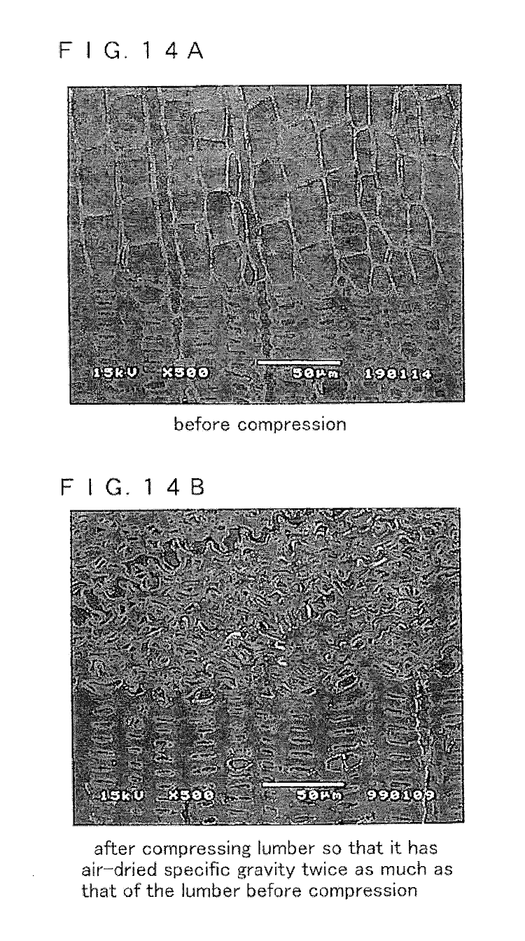

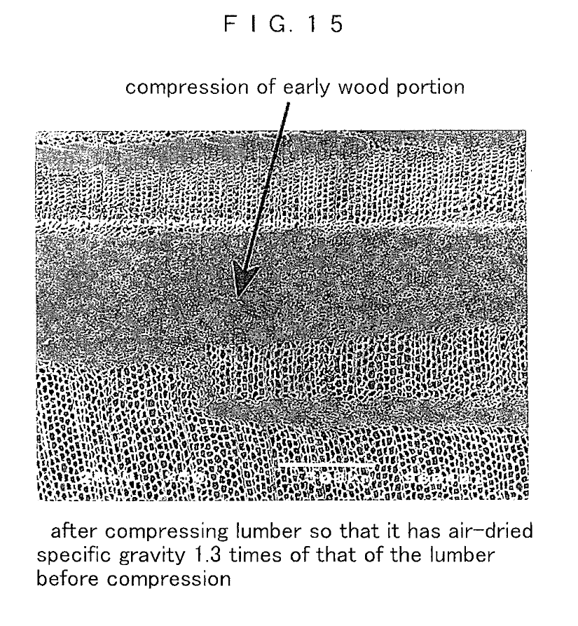

For reference, FIG. 14A shows micrographs (500-power SEM) of lumber before processing NW1 and NW2. FIG. 14B shows micrographs (500-power SEM) of plastic-worked lumber PW1 and PW2 according to the present embodiment. FIG. 14 indicates that an early wood portion mainly has deformed cells due to compression and cell walls overlap one another, thereby having an extreme reduction in porosity (in a cell cavity). Moreover, for reference, FIG. 15 shows a micrograph (50-power SEM) of plastic-worked lumber that is compressed so as to have air-dried specific gravity 1.3 times as much as that of lumber before heating and compression. FIG. 15 indicates that the plastic-worked lumber compressed so as to have air-dried specific gravity only 1.3 times as much as that of lumber before heating and compression is locally deformed due to compression and not compressed averagely in overall thickness.

Regarding this, comparative examples have a deformation due to a change in ambient conditions after production. In contrast, the plastic-worked lumber PW1 and PW2 according to the present embodiment has no deformation due to a change in ambient conditions after production. That is, the comparative examples have deformed cells due to compression. The deformation of the cells is locally concentrated in a limited part thereof. Thereby, the comparative examples have variation in dimensional change rate in products due to a change in ambient conditions. Therefore, the comparative examples have a deformation due to a change in ambient conditions in some cases. On the other hand, plastic-worked lumber PW1 and PW2 according to the present embodiment is compressed uniformly in overall thickness. Thereby, the plastic-worked lumber PW1 and PW2 according to the present embodiment is estimated to have no deformation without variation in dimensional change rate in products due to a change in ambient conditions.

Moreover, the plastic-worked lumber PW1 and PW2 according to the present embodiment has a significantly high hardness as compared with the comparative examples, which may result from the following reasons. A late wood portion has slightly deformed cells due to compression. On the other hand, an early wood portion including a surface layer portion has almost all cells that are deformed due to compression and cell walls may overlap one another. As another reason for above, porosity (in cell cavities) may significantly lower. And moreover, as a result of the lowered porosity, the late wood portion that originally has a thick cell wall and a low density may become hard and come up to a surface of a surface layer portion. That is, the late wood portion may increase in share as shown in FIG. 14B.

In particular, as shown in FIG. 13, according to plastic-worked lumber PW1 according to the present embodiment, it has air-dried specific gravity of 0.85 or more and a lowered porosity, thereby certainly having excellent properties in hardness, abrasion resistance, and stiffness similar to those of ebony.

In addition, the air-dried specific gravity means a specific gravity that is measured when lumber is dried in the air and normally represented by a specific gravity with water content of 15%. The value is obtained by comparing with the same volume of water as that measured when the lumber is dried. A higher numeric value denotes a high specific gravity. A lower numeric value denotes a low specific gravity. Some examples follow: natural ebony, 0.85 to 1.04; rosewood, approximately 1.03; Japanese cedar or those often used in Japan, 0.36; Japanese cypress, 0.44; Japanese larch, 0.50; Todo fir, 0.44; paulownia, 0.25; chestnut, 0.60; Japanese beech, 0.65; Japanese oak, 0.58; birch, 0.60; pasania, 0.61; angsana, 0.61; Apitong, 0.72; A. falcataria, 0.27; malapapaya, 0.50; Gmelina, 0.45; rubber tree, 0.64; yellow poplar, 0.45; Italian Poplar, 0.35; eucalyptus, 0.75; Kayu putih, 0.75; and Acacia mangium, approximately 063.

The air-dried specific gravity is ultimately set in consideration of a species of trees, cost, and a required property such as hardness and abrasion resistance. However, if an excessively-high compression rate is set in order to increase air-dried specific gravity, fiber that forms lumber may be broken and a crack may lose merchantability. Thereby, a value of air-dried specific gravity that is measured just before having a crack by high compression may be a maximum value. In this connection, according to the experiment and studies by the present inventors, it is found that a maximum value of air-dried specific gravity is approximately 1.2 in the case of using a Japanese cedar. Thereby, the maximum value of air-dried specific gravity according to the present invention is a finite value that depends on a species of trees and the like. In addition, lumber having air-dried specific gravity of 0.85 or more may have the same or more characteristics such as hardness and abrasion resistance as compared with ebony. The value of 0.85 in air-dried specific gravity shall not mean the exact value of 0.85 as long as it is approximately 0.85 or more, which is an approximate value including an error. A small percentage of errors are embraced therein.

As described above, plastic-worked lumber PW1 and PW2 according to the present embodiment is formed by applying external force to lumber before processing NW1 and NW2, respectively. The lumber before processing NW1 or NW2 is heated and compressed in a thickness direction thereof and plastically worked. A resultant plastic-worked lumber PW1 or PW2 after hearing and compression has air-dried specific gravity twice or more as much as those of the lumber before processing NW1 or NW2. Moreover, the plastic-worked lumber PW1 and PW2 has every acute crossing angle δ within a range of 45 degrees or less. All of the acute crossing angles δ are formed by all of annual ring lines RL on a butt end surface A of the plastic-worked lumber PW1 and imaginary borderlines drawn in a range of 2 mm or less of a pith-side cross grain surface B1 as viewed from the butt end surface A of the lumber along the pith-side cross grain surface B1 of the plastic-worked lumber PW1, or formed by all of annual ring lines RL on a butt end surface A of the plastic-worked lumber PW2 and imaginary borderlines drawn in a range of 2 mm or less of a pith-side straight grain surface C1 as viewed from the butt end surface A of the plastic-worked lumber PW2 along the pith-side straight grain surface C1 of the plastic-worked lumber PW2.

Especially, plastic-worked lumber PW1, which is an Example of the present embodiment, is formed by applying heating and compression to lumber in a vertical direction of a cross grain surface B1 or B2 of the lumber. The lumber is compressed entirely in a thickness direction thereof and plastically worked. The plastic-worked lumber PW1 thus prepared has every acute crossing angle δ within a range of 0 to 25 degrees. All of the acute crossing angles δ are formed by a pith-side borderline BL1 between a butt end surface A and a heart-side cross grain surface B1 of the lumber and annual ring lines RL on the butt end surface A of the lumber.

In addition, plastic-worked lumber PW2 as one of Examples is formed by heating and compressing lumber in a vertical direction of a straight grain surface C1 or C2. The lumber is compressed entirely in a thickness direction thereof and plastically worked. The plastic-worked lumber PW2 thus prepared has every acute crossing angle δ within a range of 10 to 45 degrees. All of the acute crossing angles δ are formed by a pith-side borderline BL2 between a butt end surface A and a heart-side straight grain surface B2 of the lumber and annual ring lines RL on the butt end surface A of the lumber.

Therefore, according to the present embodiment, plastic-worked lumber PW1 or PW2 has every acute crossing angle δ within a range of 45 degrees or less. All of the acute crossing angles δ are formed by a pith-side borderline BL1 of the plastic-worked lumber PW1 and annual ring lines RL on a butt end surface A of the plastic-worked lumber PW1 or formed by a borderline BL2 of the plastic-worked lumber PW2 and annual ring lines RL on a butt end surface A of the plastic-worked lumber PW2. In addition, the plastic-worked lumber PW1 and PW2 is physically stable and has a reduced variation in quality among products. No deformation is occurred by a change in ambient conditions after processing. Moreover, the plastic-worked lumber PW1 and PW2 has a high hardness, thereby hardly having a flaw or a dent.

In addition, plastic-worked lumber PW1 and PW2 are described in the present embodiment. However, a process for manufacturing the plastic-worked lumber PW1 and PW2 are described in the embodiment as a process for manufacturing plastic-worked lumber.

Especially, the plastic-worked lumber PW1 and PW2 according to the present embodiment have air-dried specific gravity of 0.85 or more and a lowered porosity, thereby certainly obtaining an excellent hardness similar to that of ebony.

Moreover, the plastic-worked lumber PW1 and PW2 according to the present embodiment has hardness of 25 N/mm² or more that is measured by a hardness test provided in JIS-Z-2101-1994. The value of 25 N/mm² is higher than that of a broad-leaved tree. The broad-leaved tree is used for a normal floor material. Thereby, the plastic-worked lumber PW1 and PW2 have hardness enough to use for a floor material and so on that are readily subject to a concentrated load or a shock load and require a high hardness.

Therefore, the plastic-worked lumber PW1 and PW2 according to the present embodiment may be used in a wide range of applications such as residential armoring materials used as a floor material, a wainscot, a furniture material, and surface coating, a school desk, a top panel for a table, a door, and the like.

In addition, the plastic-worked lumber PW1 and PW2 according to the present embodiment is manufactured by using a press machine 10. The press machine 10 is divided into plural parts including an upper press plate 10A and a lower press plate 10B. The upper press plate 10A and the lower press plate 10B form an internal space IS. The press machine 10 may freely apply a press-compression by changing a volume of the internal space IS. With the press machine 10, lumber before processing NW1 to be a material of plastic-worked lumber PW1 is placed on the internal space IS and heated and compressed in a vertical direction of a cross grain surface B1 or B2 and lumber before processing NW2 to be a material of plastic-worked lumber PW2 is heated and compressed in a vertical direction of a straight grain surface C1 or C2. The lumber before processing NW1 or NW2 is kept in the sealed internal space IS. While the internal space IS is sealed, steam pressure in the internal space IS is controlled and fixed. Then, the lumber before processing NW1 or NW2 is cooled to form plastic-worked lumber PW1 or PW2. That is, the plastic-worked lumber PW1 and PW2 according to the present embodiment is effectively compressed and deformed, thereby preventing a return to their original shapes after releasing compression, a swelling deformation, and a surface crack that is a so-called puncture. Therefore, the plastic-worked lumber PW1 and PW2 according to the present embodiment may keep a high quality and a preferable productivity may be provided.

In the practice of the present invention, a thinning material, a damaged lumber that is useless in a log due to a damage by falling or breading a core with a natural disaster such as wind damage, flood damage, snow damage, forest fire, freezing damage and insect damage, an end material and the like may be used as lumber before processing NW1 or NW2 that forms plastic-worked lumber PW1 or PW2. Thereby, a reduction in cost and a contribution to beautifying the environment may be achieved.

In addition, not all of the numeric values described in the present embodiment of the invention indicate a critical value, and a certain numeric value indicates an appropriate value which is suitable for the embodiment. Even if the above numeric values may be changed slightly, the present invention can be practiced as well.

The preferred embodiments described herein are illustrative and not restrictive, the scope of the invention being indicated in the appended claims and all variations which come within the meaning of the claims are intended to be embraced therein.

1. Plastic-worked lumber having air-dried specific gravity of 0.85 or more with water content of 15% and acute crossing angles within a range of 45 degrees or less, the plastic-worked lumber being formed by applying heating and compression to lumber in a thickness direction thereof, the lumber being heated and compressed and plastically worked, a resultant plastic-worked lumber after the heating and compression being dried in the air so as to have the air-dried specific gravity of 0.85 or more with the water content of 15% and acute crossing angles within a range of 45 degrees or less, the acute crossing angles being formed by all of annual ring lines on a butt end surface of the plastic-worked lumber and a heart-side cross grain surface or a pith-side straight grain surface of the plastic-worked lumber.

2. A process for manufacturing plastic-worked lumber, comprising the steps of:
applying heating and compression to lumber in a thickness direction thereof so that the lumber is heated and compressed and plastically worked; and
drying a resultant plastic-worked lumber after the heating and compression in the air so as to have air-dried specific gravity of 0.85 or more with water content of 15% and acute crossing angles within a range of 45 degrees or less, the acute crossing angles being formed by all of annual ring lines on a butt end surface of the plastic-worked lumber after heating and compression and a heart-side cross grain surface or a pith-side straight grain surface of the plastic-worked lumber.
